(19) United States
(12) Patent Application Publication
(10) Pub. No.: US 2010/0028487 A1
(43) Pub. Date: Feb. 4, 2010

(54) Method of producing vinegar and vinegar produced by this method

(76) Inventor: Yasushi Ogasawara, Hekinan-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/449,688

(22) PCT Filed: Feb. 26, 2008
(86) PCT No.: PCT/JP2008/053238

§ 371 Date: Aug. 20, 2009

(30) Foreign Application Priority Data
Mar. 26, 2007 (JP) 2007-078537

(51) Int. Cl. C12J 1/00; A23L 1/22; A23L 1/24

(52) U.S. Cl. 426/17; 426/650; 426/590

(57) ABSTRACT

Provided are a method of producing a vinegar which can be utilized for a wide range of use such as drinking and cooking by reducing an unpleasant smell peculiar to a vinegar manufactured from a bran-containing raw material; and a vinegar produced by the method. Specifically, provided are a method of producing a vinegar including using a bran-containing raw material; and allowing to contain ammonia and a sugar into the vinegar so that an ammonia concentration is 40 to 250 mg/100 ml and a sugar concentration is to 50 g/100 ml, to thereby reduce a peculiar unpleasant smell; the vinegar produced by the method; and a food or beverage containing the vinegar.

### TECHNICAL FIELD

The present invention relates to a method of producing a vinegar, and a vinegar produced by the method. Specifically, the present invention relates to: a method of producing a vinegar, which allows to contain ammonia into the vinegar manufactured from a bran-containing raw material, such as black vinegar and unpolished-rice vinegar manufactured from unpolished rice, to reduce an unpleasant smell peculiar to a bran-containing vinegar in the extent that an astringent and discordant taste due to ammonia is not sensed; and a vinegar which is produced by the method.

### BACKGROUND ART

In recent years, ingestion of vinegar as a beverage has become widespread. In particular, because black vinegar produced from unpolished rice as a raw material is recognized to have various healthcare functions, the ingestion of black vinegar as a beverage is in currency and black vinegar becomes very popular as a sour seasoning such as citrus seasoned soy sauce containing black vinegar.

However, black vinegar or the like manufactured from unpolished rice as a raw material has had problems in that black vinegar or the like has a sharp irritating smell derived from acetic acid in the vinegar and, in addition, has an unpleasant smell peculiar to the bran-containing vinegar, and hence, use thereof has been limited.

As a method of reducing the unpleasant smell peculiar to the vinegar manufactured from unpolished rice, there is disclosed, for example, a method of adding a seaweed broth to a citrus seasoned soy sauce containing a black vinegar and a soy sauce (see, for example, Patent Document 1).

However, such addition of the seaweed broth causes problems in that suitability of the vinegar as a beverage decreases, the taste and flavor of seaweed is excessively emphasized as a seasoning, and the like. Therefore, it has been desired to develop a method by which the unpleasant smell peculiar to the vinegar manufactured from unpolished rice can be reduced and which is applicable to a wide range of use.

Note that, as a method of improving taste and flavor of vinegar, there have been disclosed a method of adding sucralose to a black vinegar (see, for example, Patent Document 2), a method of allowing to contain sotolone and furfural (see, for example, Patent Document 3), and the like. However, those methods are for reducing a stimulus sour taste and an acid smell derived from acetic acid that is a main organic acid in vinegar, and are not for reducing the unpleasant smell peculiar to black vinegar or the like.

Meanwhile, ammonia which attracts attention in the present invention has a strong smell, and hence, it has been conventionally considered that the smaller concentration of ammonia in food is the more preferable. Influence such as reduction of the unpleasant smell peculiar to black vinegar by allowing to contain ammonia at a specific concentration has not been known.

On the other hand, as for allowing to contain a sugar into vinegar, a method of adding a sugar such as honey to a vinegar to reduce the acid taste before drinking has been well known. Moreover, a method to manufacture a vinegar using a raw material such as unpolished rice and having a higher sugar concentration than the conventional black vinegar, characterized by having the acidity of 2% or more, the sugar content of 10-30%, and the extract content of 16-40%, by adjusting the sugar content of alcohol-containing mash within 10 to 30% in advance, then performing acetic acid fermentation (for example, refer to patent document 4) is disclosed.

However, such a method of adding a sweet component can reduce the irritation of the acid taste, but there has still remained a problem in that the method cannot remove an unpleasant smell peculiar to black vinegar.

That is, it has been required to develop a method of producing a black vinegar which has a reduced unpleasant smell peculiar to black vinegar and is easier to drink.

Patent Document 1: JP 2004-49104 A

Patent Document 2: JP 2002-335924 A

Patent Document 3: JP 2001-69940 A

Patent Document 4: JP 61-96981 A

### DISCLOSURE OF THE INVENTION

### Problem to be Solved by the Invention

It is an object of the present invention to provide: a method of producing a vinegar which is applicable to a wide range of use such as drinking and cooking, which involves reducing an unpleasant smell peculiar to a vinegar manufactured from a bran-containing raw material; and a vinegar produced by the method. Moreover, it is another object of the present invention to provide a food or beverage in which a peculiar unpleasant smell is reduced by using the vinegar.

### Means for Solving the Problems

The inventor of the present invention has made extensive studies to attain the above-mentioned objects. As a result, the inventor of the present invention has surprisingly found that an unpleasant smell peculiar to a bran-containing vinegar can be reduced by allowing to contain ammonia and a sugar at specific concentrations into a vinegar manufactured from a bran-containing raw material, and hence, the vinegar has a significantly improved quality and organoleptically excellent taste. The present invention has thus been completed according to the finding.

That is, a first embodiment of the present invention relates to a method of producing a vinegar, comprising: using a bran-containing raw material; and allowing to contain ammonia and a sugar into the vinegar so that an ammonia concentration is 40 to 250 mg/100 ml and a sugar concentration is 5 to 50 g/100 ml.

Next, a second embodiment of the present invention relates to the method of producing a vinegar according to the first embodiment, comprising allowing to contain ammonia into the vinegar so that the ammonia concentration is 100 to 200 mg/100 ml.

Further, a third embodiment of the present invention relates to a vinegar, which is produced by the method according to the first or second embodiment.

Still further, a fourth embodiment of the present invention relates to a food or beverage, comprising the vinegar according to the third embodiment.

### EFFECTS OF THE INVENTION

According to the present invention, an unpleasant smell peculiar to a bran-containing vinegar can be reduced in a vinegar manufactured from a bran-containing raw material, and the vinegar is applicable to a wide range of use including drinking, seasoning and the like. In addition, it is possible to provide a food or beverage in which the vinegar described above is used and a peculiar unpleasant smell is reduced.

### BEST MODE FOR CARRYING OUT THE INVENTION

Hereinafter, the present invention is described in detail.

The first embodiment of the present invention relates to a method of producing a vinegar, comprising: using a bran-containing raw material; and allowing to contain ammonia into the vinegar so that an ammonia concentration is 40 to 250 mg/100 ml and allowing to contain a sugar into the vinegar so that a sugar concentration is 5 to 50 g/100 ml.

Meanwhile, the second embodiment of the present invention relates to the method of producing a vinegar according to the first embodiment, in which ammonia is allowed to be contained into the vinegar so that the ammonia concentration is 100 to 200 mg/100 ml.

Vinegar is roughly classified into brewed vinegar and synthetic vinegar. It is preferable that the vinegar in the present invention is brewed vinegar which is obtained by subjecting a raw material to acetic acid fermentation. Examples of the brewed vinegar include rice black vinegar, unpolished-rice vinegar, barley black vinegar, rice vinegar, and grain vinegar. Among them, rice black vinegar and unpolished-rice vinegar are particularly preferable.

Note that the term “rice black vinegar” is defined by Vinegar Quality Standards (notification No. 1821, Ministry of Agriculture, Forestry and Fisheries of Japan, amended on Oct. 7, 2004) as “a kind of grain vinegar, which is produced by using only rice (except rice that is polished after removing the whole bran layer of unpolished rice) or the rice added with wheat or barley as raw material, and which uses the rice in an amount of 180 g or more per 1 L of the grain vinegar, and is colored brown or blackish brown through fermentation and aging”. The “barley black vinegar” is also defined as “a kind of grain vinegar, which is produced by using only barley as raw material in an amount of 180 g or more per 1 L of the grain vinegar, and is colored brown or blackish brown through fermentation and aging”.

The term “bran” as used in the present invention refers to an outer portion (bran layer) of grains which is produced in a process of polishing grains. In the case where the grain is rice, the term “bran” preferably indicates one produced when a degree of polishing the surface of grains (hereinafter, sometimes referred to as “polishing ratio”) is about less than 6%, while in the case where the grain is barley, the term “bran” preferably indicates one produced when the polishing ratio is about less than 30%.

The term “bran-containing raw material” as used in the present invention encompasses not only so-called bran such as rice bran, red bran, and barley bran but also grains containing at least a part of a bran layer, such as unpolished rice, unpolished barley, and partially polished grain from which all of the bran layer is not removed. Of those, the unpolished rice and partially polished rice are preferably used, and the unpolished rice is particularly preferably used.

Bran abundantly contains nutritional components such as proteins, minerals, dietary fibers, and oil contents, and also contains a large number of aromatic components such as aldehyde compounds including hexanal and alcohol compounds including hexanol.

The causative substance of the unpleasant smell peculiar to a vinegar manufactured from a bran-containing raw material is not fully clarified. However, it is assumed that the substances converted from the above-mentioned aromatic components through alcoholic fermentation or acetic acid fermentation are intricately related.

As the raw material to be used in the method of producing a vinegar of the present invention, any of other grains containing no bran, such as polished rice, wheat, barley, and corn, may be used in combination with the bran-containing raw material.

In the present invention, those raw materials including the bran-containing raw material can be used in an amount of 40 to 1,200 g, and preferably 180 to 1,200 g per liter of vinegar. Of those, the bran-containing raw material is used in an amount of 40 to 700 g, and preferably 180 to 700 g per liter of vinegar.

The method of producing a vinegar of the present invention does not have particular limitation except that the above-mentioned “bran-containing raw material” is used as a raw material and that ammonia and a sugar are allowed to be contained at specific concentrations, and general methods of producing vinegar can be adopted.

Hereinafter, an example of general methods of producing vinegar is described.

That is, first, glucoside in the bran-containing raw material is saccharified with koji or saccharifying enzymes, then lees of saccharified rice and/or barley and the like are removed by filtration etc., and a saccharified solution is prepared. Then the saccharified solution is subjected to alcoholic fermentation with yeast, solids such as sake lees are removed by filtration etc., and an alcoholic fermented broth is obtained. Furthermore, the obtained alcoholic fermented broth as an alcohol-containing solution is mixed with seed vinegar and is subjected to acetic acid fermentation with acetic acid bacteria. After completion of acetic acid fermentation, the fermented broth is subjected to aging as appropriate, filtered, sterilized, and filled into containers such as bottles, thereby producing a final vinegar product.

Another producing method in which, in a container such as a jar, above saccharification, alcoholic fermentation, and acetic acid fermentation processes are concurrently performed is also known.

On the other hand, the method of producing vinegar of the present invention may adopt a method of allowing acetic acid fermentation to proceed by adding an alcohol to a saccharified solution obtained by saccharifying a bran-containing raw material in the same manner as mentioned above.

In the present invention, the method for acetic acid fermentation may be a so-called static fermentation method in which acetic acid bacteria are allowed to grow on a surface of a fermenting broth in a static state or a submerged fermentation method performed using a submerged fermenter.

When a vinegar is manufactured by such a general method, almost all of sugar derived from rice, barley or the like as raw material is converted into alcohol and consumed in the alcoholic fermentation process, and the sugar concentration of the obtained vinegar is generally low, that is, a vinegar having the sugar concentration of 5 weight/volume % or more, for example, is not manufactured in general.

In the method of producing a vinegar of the present invention, it is essential for the method to allow thus produced vinegar to contain ammonia at a concentration of 40 to 250 mg/100 ml.

Ammonia is also present in a conventional, general vinegar, but the ammonia concentration is at most about 25 mg/100 ml. In addition, ammonia has been conventionally considered to be a factor of impairing the taste and flavor of a seasoning, and hence, an attempt to increase the ammonia concentration has not been conducted.

In the method of producing a vinegar of the present invention, ammonia is allowed to be contained into the vinegar in a final concentration of 40 to 250 mg/100 ml, and preferably 100 to 200 mg/100 ml. When a concentration of ammonia is less than the lower limit, it is not preferable because the unpleasant smell peculiar to the vinegar is not reduced. Meanwhile, when a concentration exceeds the upper limit, it is not preferable either, because an ammonia smell becomes too strong.

In the present invention, a method of adjusting the concentration of ammonia in a vinegar within the above-mentioned range is not particularly limited as long as the final concentration of ammonia in a vinegar can be adjusted within the above-mentioned range. In addition, the adjustment may be performed in any stage in the steps of producing a vinegar.

Note that, in the case of producing the food or beverage containing the vinegar according to the third embodiment, ammonia may be allowed to be contained into the food or beverage in the steps of producing the food or beverage.

In the present invention, examples of the method of allowing to contain ammonia and a sugar into a vinegar include: a method of adding an ammonia and sugar-containing material in the production step; a method of brewing by fermentation in the production step; and a method of combining these methods.

In the present invention, in the case where ammonia is allowed to be contained into a vinegar by adding an ammonia-containing material, ammonia may be added in any stage in the steps of producing a vinegar. For example, ammonia can be added to an alcohol-containing mash, a saccharified solution, or a vinegar after completion of acetic acid fermentation.

Note that the material containing ammonia may be one that can be used in food. Examples thereof include ammonia, ammonium chloride, ammonium carbonate, ammonium hydrogen carbonate, ammonium sulfate, diammonium hydrogen phosphate, iron ammonium citrate, aluminum ammonium sulfate, and ammonium glutamate. In addition, a food containing ammonia at a high concentration such as fermented fish sauce or fish extract can also be used.

The ammonia concentration can be measured by, for example, neutralization titration of a distillate obtained by steam distillation under alkaline conditions. That is, 1 ml of a sample is diluted to 100 ml with distilled water, and 25 ml of a solution of 40% sodium hydroxide is added, followed by distillation. The resultant distillate is absorbed in 20 ml of 0.1 N sulfuric acid, and neutralization titration is conducted with a solution of 0.1 N sodium hydroxide to determine a titer. The titer can be converted into the concentration of ammonia by the following formula 1.

Concentration of ammonia (mg/100 ml)=(V2−V1)×F×170 (Formula 1)

In the above-mentioned formula 1, V2 is the volume (ml) of a solution of 0.1 N sodium hydroxide used for the titration of 20 ml of 0.1 N sulfuric acid before absorption of the distillate, while V1 is the volume (ml) of the solution of 0.1 N sodium hydroxide used for the titration of 20 ml of 0.1 N sulfuric acid after absorption of the distillate.

In addition, F is a titration factor of the solution of 0.1 N sodium hydroxide.

Further, in the method of producing a vinegar of the present invention, a sugar is allowed to be contained into a vinegar in a final concentration of 5 to 50 g/100 ml. This is because the concentration of the sugar of less than the lower limit causes strong adverse effects such as emphasis of an astringent and discordant taste due to ammonia. Meanwhile, a concentration exceeding the upper limit is also not preferable because the vinegar is too sweet and has a taste unfavorable for drinking and seasoning and because growth of acetic acid bacteria becomes difficult and acetic acid fermentation can not be performed well.

In the present invention, a method of adjusting the sugar concentration in a vinegar within the above-mentioned range is not particularly limited as long as the final concentration of a sugar in a vinegar can be adjusted within the above-mentioned range. In addition, the adjustment may be performed in any stage in the steps of producing a vinegar.

Note that, in the case of producing a food or beverage containing a vinegar according to the third embodiment, a sugar may also be allowed to be contained into the food or beverage in the steps of producing the food or beverage.

In the present invention, examples of the method of allowing to contain a sugar into a vinegar include: a method of adding a sugar-containing material in the production step; a method of brewing by fermentation in the production step; and a method of combining these methods.

In the present invention, in the case where a sugar is allowed to be contained into a vinegar by adding the sugar-containing material, the sugar may be added in any stage in the steps of producing a vinegar. For example, the sugar-containing material may be added to a vinegar after completion of acetic acid fermentation, an alcohol-containing mash, or a saccharified solution.

The sugar-containing material used in the present invention is not particularly limited as long as the material contains a sweet-tasting glucoside. Examples thereof include a material containing a glucoside such as glucose, fructose, maltose, sucrose, or sorbitol. Meanwhile, as the sugar-containing material, a food containing a glucoside as described above may be used. For example, a grain-saccharified solution, honey, liquid sugar, starch syrup, and fruit juice may be used. In the case of production of a black vinegar, a saccharified solution of a raw material, i.e., “rice (except rice that is polished after removing the whole bran layer of unpolished rice) or the rice added with wheat or barley” may be used.

Note that the term “sugar” as used in the present invention is a collective term of sweet-tasting glucoside, i.e., glucose, maltose, fructose, sucrose, sorbitol, and glycerol.

In the present invention, the concentration of a sugar (g/100 ml) can be obtained by summing the concentrations of the above individual glucosides. The concentrations of the individual glucosides can be measured by high performance liquid chromatography (HPLC) for saccharide analysis under the following HPLC conditions.

<HPLC Conditions>

Column: Shodex Asahipak NH2P-50 4E (4.6 mmID×250 mm) (manufactured by SHOWA DENKO K.K.)

Eluate: CH₃CN/H₂O=75/25

Detection: RI detector

Flow rate: 1.0 mL/min

Column temperature: 30° C.

The concentration of the organic acids such as acetic acid in a vinegar manufactured by the method of the present invention is not especially limited. However, the acidity is preferably approximately 2-6% from the view point that it is drinkable deliciously only by diluting with water. The acidity (%) can be obtained by performing neutralization titration of the organic acids such as acetic acid with a sodium hydroxide solution and converting into the acetic acid concentration.

As described above, in the present invention, if ammonia is allowed to be contained, the unpleasant smell peculiar to a bran-containing vinegar can be reduced. Moreover, if a sugar is allowed to be contained, adverse effects of ammonia on the taste can be reduced.

It is the invention according to the third embodiment of the present application to provide the thus-produced ammonia and sugar-containing vinegar. The vinegar of the present invention can be utilized as a seasoning without modification, and has a reduced unpleasant smell peculiar to the bran-containing vinegar.

Further, as set forth in the fourth embodiment, the vinegar of the present invention can also be utilized for the production of foods and beverages. Examples of the food or beverage containing the vinegar of the present invention include, but not limited to: beverages such as soft drinks; seasonings such as citrus seasoned soy sauce, dressing, noodle soup, and sauces; and foods such as sushi, vinegared food, and salad.

Those foods and beverages can be produced by general methods. A soft drink containing the vinegar of the present invention can be produced by, for example, mixing a fruit juice, honey, and the like to the vinegar of the present invention and appropriately diluting the mixture. In addition, a citrus seasoned soy sauce, dressing, noodle soup, and sauces each containing the vinegar of the present invention can be produced by, for example, adding sugar, salt, soy sauce, bouillon, oil, spices, and the like to the vinegar of the present invention.

### EXAMPLES

Hereinafter, the present invention is described in more detail by way of test examples and examples. However, the present invention is not limited to these examples.

### Test Example 1

### Reduction of Peculiar Unpleasant Smell by Ammonia

### (1) Preparation of Alcoholic Fermented Broth

Firstly, unpolished rice was steamed under normal pressure, cooled, inoculated with seed koji fungus Aspergillus oryzae, cultured at 30° C. for 3 days, and dried, according to the known method, whereby rice koji was obtained.

Six Kg of unpolished rice that was ground, 1 Kg of the ground rice koji obtained above, 20 g of an α-amylase preparation (Kleistase T-5, manufactured by Daiwa Kasei K. K.), 20 g of a glucoamylase preparation (Sumizyme, manufactured by Shin Nihon Chemical Co., Ltd.), and 40 g of a protease preparation (Sumizyme LP-50, manufactured by Shin Nihon Chemical Co., Ltd.) were suspended in water so that the total volume of the suspension was adjusted to 20 liters. The suspension was added with 25 g of yeast (Saccharomyces cerevisiae, manufactured by Oriental Yeast Co., Ltd.), and subjected to alcoholic fermentation at 30° C. for 5 days. After that, the resultant product was filtrated, to thereby obtain 16 liters of an alcoholic fermented broth having an alcohol concentration of 15 vol %.

### (2) Preparation of Vinegar

The alcoholic fermented broth prepared in the above-mentioned section (1) was diluted twice with water, and a seed culture containing an acetic acid bacteria Acetobacter aceti was inoculated to perform acetic acid fermentation in the submerged fermenter under the conditions of 30° C., 500 rpm, and 0.2 vvm, whereby a fermented broth having an acidity of 7.0 weight/volume % was obtained. The fermented broth was filtrated, and the filtrate was diluted with water, whereby a vinegar having an acidity of 4.5 weight/volume % was obtained.

Note that the used seed culture (seed vinegar) described above was a fermenting broth containing acetic acid bacteria Acetobacter aceti having vigorous activity in continuous acetic acid fermentation by using the rice alcoholic fermented broth described in the above-mentioned section (1) in a submerged fermenter under conditions: at 30° C., 500 rpm, 0.2 vvm, acidity: 7.5 weight/volume % and the alcohol concentration: 0.4 volume/volume %.

### (3) Preparation of Vinegars Having Different Ammonia Concentrations, and Organoleptic Test Thereof.

The vinegar obtained in the above-mentioned section (2) (test a) contained ammonia at a concentration of 13 mg/100 ml and no sugar. To the vinegar obtained in the above-mentioned section (2), added was ammonium hydrogen carbonate, to thereby obtain vinegars in which ammonia was added so that a concentration was 33 to 300 mg/100 ml in total (tests b to g).

Those vinegars were subjected to organoleptic tests by 15 skilled panels to evaluate the flavor and taste of the vinegars. The results are shown in Table 1.

Note that an unpleasant smell peculiar to a vinegar obtained from a bran-containing raw material was evaluated according to the following 3 scales, that is, 1: presence of peculiar unpleasant smell, 2: almost no presence of peculiar unpleasant smell, and 3: no presence of peculiar unpleasant smell.

In addition, an ammonia smell was evaluated similarly according to the following 3 scales, that is, 1: presence of ammonia smell, 2: almost no presence of ammonia smell, and 3: no presence of ammonia smell.

Further, an astringent and discordant taste of ammonia was evaluated similarly according to the following 3 scales, that is, 1: presence of astringent and discordant taste, 2: almost no presence of astringent and discordant taste, and 3: no presence of astringent and discordant taste.

Average values obtained by averaging the evaluation values of the respective panels for the peculiar unpleasant smell, ammonia smell, and astringent and discordant taste of ammonia were regarded as evaluated values.

TABLE 1

| | Ammonia | Peculiar | | Astringent and |
|---|---|---|---|---|
| | concentration | unpleasant | Ammonia | discordant taste |
| Test | (mg/100 ml) | smell | smell | of ammonia |
| Test a | 13 | 1.6 | 2.7 | 2.4 |
| Test b | 33 | 1.8 | 2.7 | 2.2 |
| Test c | 40 | 2.2 | 2.6 | 2.0 |
| Test d | 100 | 2.5 | 2.6 | 1.8 |
| Test e | 200 | 2.6 | 2.4 | 1.8 |
| Test f | 250 | 2.3 | 2.1 | 1.7 |
| Test g | 300 | 2.2 | 1.8 | 1.5 |

As is clear from Table 1, the vinegars containing ammonia at concentrations of 40 mg/100 ml or more (tests c to g) were confirmed to have a significantly reduced peculiar unpleasant smell as compared to the vinegars of tests a and b. In particular, in the case of the vinegars containing ammonia at concentrations of 100 mg/100 ml or more, the peculiar unpleasant smell was significantly reduced.

Meanwhile, it was found that in the case of an ammonia concentration of 250 mg/100 ml or less (tests a to f), the ammonia smell was hardly sensed, which meant no problem, while in the case of an ammonia concentration of 300 mg/100 ml, the ammonia smell was sensed, which was not preferable.

On the other hand, as for the taste, the astringent and discordant taste due to ammonia was sensed in the case of an ammonia concentration of 40 mg/100 ml or more. Therefore, it was found that the addition of ammonia alone did not lead to a preferable result.

### Test Example 2

### Reduction of Astringent and Discordant Taste Due to Ammonia by Sugar

To each of the filtrates (57 ml) of the vinegar having an acidity of 7.0% obtained in the above-mentioned section (2) of Test Example 1, added were 465 mg of ammonium hydrogen carbonate and each of 0, 3, 5, 10, 20, and 50 g of sugar, and the resultants were filled up to 100 ml with water, whereby vinegars for tests h to m were obtained. The ammonia concentrations of the vinegars were found to be 110 mg/100 ml.

Those vinegars were subjected to organoleptic tests by 15 skilled panels to evaluate the flavor and taste of the vinegars. The results are shown in Table 2.

Note that an unpleasant smell peculiar to a bran-containing vinegar was evaluated according to the following 3 scales, that is, 1: presence of peculiar unpleasant smell, 2: almost no presence of peculiar unpleasant smell, and 3: no presence of peculiar unpleasant smell.

In addition, an ammonia smell was evaluated according to the following 3 scales, that is, 1: presence of ammonia smell, 2: almost no presence of ammonia smell, and 3: no presence of ammonia smell.

Further, an astringent and discordant taste of ammonia was evaluated according to the following 3 scales, that is, 1: presence of astringent and discordant taste, 2: almost no presence of astringent and discordant taste, and 3: no presence of astringent and discordant taste.

Average values obtained by averaging the evaluation values of the respective panels for the peculiar unpleasant smell, ammonia smell, and astringent and discordant taste of ammonia were regarded as evaluated values.

TABLE 2

| | Sugar | Peculiar | | Astringent and |
|---|---|---|---|---|
| | concentration | unpleasant | Ammonia | discordant taste |
| Test | (mg/100 ml) | smell | smell | of ammonia |
| Test h | 0 | 2.6 | 2.6 | 1.6 |
| Test I | 3 | 2.5 | 2.5 | 1.8 |
| Test j | 5 | 2.6 | 2.7 | 2.2 |
| Test k | 10 | 2.5 | 2.6 | 2.4 |
| Test l | 20 | 2.5 | 2.5 | 2.7 |
| Test m | 50 | 2.7 | 2.6 | 2.8 |

As is clear from Table 2, the vinegars containing ammonia were confirmed to have significantly reduced an astringent and discordant taste by adding sugar at a concentration of 5 g/100 ml or more.

### Example 1, Comparative Example 1

### Effects Achieved when Ammonia is Added to Unpolished Rice Black Vinegar Containing Sugar

### (1) Preparation of Saccharified Solution

Six Kg of unpolished rice that was ground was suspended in water so that the total volume of the suspension was adjusted to 20 liters. The suspension was added with 20 g of an α-amylase preparation (Kleistase T-5, manufactured by Daiwa Kasei K.K.), and liquefied while maintaining at 90° C. for 90 minutes with stirring. The resultant mixture was heated at 120° C. for 20 minutes to inactivate the α-amylase, and then cooled to 58° C. The resultant mixture was added with 40 g of a glucoamylase preparation (Sumizyme, manufactured by Shin Nihon Chemical Co., Ltd.) and 10 g of a protease preparation (Sumizyme LP-50, manufactured by Shin Nihon Chemical Co., Ltd.), followed by a saccharification treatment at 58° C. for additional 18 hours. After that, the resultant product was filtrated with filter press, to thereby obtain 15 liters of an unpolished-rice-saccharified solution.

### (2) Preparation of Alcoholic Fermented Broth

Firstly, unpolished rice was steamed under normal pressure, cooled, inoculated with seed koji fungus Aspergillus oryzae, cultured at 30° C. for 3 days, and dried, according to the known method, whereby rice koji was obtained.

Six Kg of unpolished rice that was ground, 1 Kg of the ground rice koji obtained above, 20 g of an α-amylase preparation (Kleistase T-5, manufactured by Daiwa Kasei K. K.), 20 g of a glucoamylase preparation (Sumizyme, manufactured by Shin Nihon Chemical Co., Ltd.), and 40 g of a protease preparation (Sumizyme LP-50, manufactured by Shin Nihon Chemical Co., Ltd.) were suspended in water so that the total volume of the suspension was adjusted to 20 liters. The suspension was added with 25 g of yeast (Saccharomyces cerevisiae, manufactured by Oriental Yeast Co., Ltd.), and subjected to alcoholic fermentation at 30° C. for 5 days. After that, the resultant product was filtrated, to thereby obtain 16 liters of an alcoholic fermented broth having an alcohol concentration of 15 vol %.

### (3) Preparation of Vinegar

A mixture was prepared by mixing 8 parts by volume of the saccharified solution prepared in the above-mentioned section (1), 14 parts by volume of the alcoholic fermented broth prepared in the above-mentioned section (2), and 48 parts by volume of water, and was added to 30 parts by volume of a seed culture (seed vinegar) in a submerged fermenter. After completion of acetic acid fermentation, the fermented broth was filtrated, to thereby obtain a rice black vinegar.

Note that the used seed culture (seed vinegar) was a fermenting broth containing acetic acid bacteria Acetobacter aceti having vigorous activity in continuous acetic acid fermentation by using the rice alcoholic fermented broth described in the above-mentioned section (2) in a submerged fermenter under conditions: at 30° C., 500 rpm, 0.2 vvm, acidity: 7.5 weight/volume % and the alcohol concentration: 0.4 volume/volume %.

### (4) Preparation of Vinegars Having Different Ammonia Concentrations, and Organoleptic Test Thereof.

The vinegar obtained in above-mentioned section (3) (Comparative Example 1) contained ammonia at a concentration of 20 mg/100 ml and a sugar at a concentration of 6.6 mg/100 ml. Then, to the vinegar obtained in the above-mentioned section (3) (Comparative Example 1), added was ammonium hydrogen carbonate so that the ammonia concentration was adjusted to 100 mg/100 ml, to thereby obtain a vinegar of Example 1.

Those vinegars of Comparative Example 1 and Example 1 were subjected to organoleptic tests by 15 skilled panels to evaluate the flavor and taste of the vinegars. The results are shown in Table 3.

Note that and an unpleasant smell peculiar to a bran-containing vinegar was evaluated according to the following 3 scales, that is, 1: presence of peculiar unpleasant smell, 2: almost no presence of peculiar unpleasant smell, and 3: no presence of peculiar unpleasant smell.

In addition, an ammonia smell was evaluated similarly according to the following 3 scales, that is, 1: presence of ammonia smell, 2: almost no presence of ammonia smell, and 3: no presence of ammonia smell.

Further, an astringent and discordant taste of ammonia was evaluated similarly according to the following 3 scales, that is, 1: presence of astringent and discordant taste, 2: almost no presence of astringent and discordant taste, and 3: no presence of astringent and discordant taste.

Average values obtained by averaging the evaluation values of the respective panels for the peculiar unpleasant smell, ammonia smell, and astringent and discordant taste of ammonia were regarded as evaluated values.

TABLE 3

| | Ammonia | Peculiar | | Astringent and |
|---|---|---|---|---|
| | concentration | unpleasant | Ammonia | discordant taste |
| Test | (mg/100 ml) | smell | smell | of ammonia |
| Comparative | 20 | 1.6 | 2.7 | 2.6 |
| Example 1 | | | | |
| Example 1 | 100 | 2.6 | 2.5 | 2.5 |

As is clear from Table 3, the vinegar containing ammonia at a concentration of 20 mg/100 ml (Comparative Example 1) was confirmed to have a peculiar unpleasant smell, while the vinegar containing ammonia at a concentration of 100 mg/100 ml (Example 1) was confirmed to have a significantly reduced peculiar unpleasant smell as compared to the vinegar of Comparative Example 1. Meanwhile, those vinegars contained a sugar at a concentration of 6.6 g/100 ml and had no astringent and discordant taste due to ammonia.

### Example 2, Comparative Example 2

### Production of Dressing

The vinegar of Example 1 (50 parts by weight), salt (5 parts by weight), sugar (5 parts by weight), white pepper (a little amount), and cooking oil (30 parts by weight) were mixed to prepare a dressing of Example 2.

On the other hand, as a control, the respective raw materials were mixed at the same ratio as above except that the vinegar of Comparative Example 1 was used, to thereby prepare a dressing of Comparative Example 2.

The dressing of Example 2 and the dressing of Comparative Example 2 were subjected to organoleptic tests by 15 panels to evaluate the flavor of the dressings. The results are shown in Table 4.

Note that evaluation was conducted according to the following 3 scales, that is, 1: presence of peculiar unpleasant smell, 2: almost no presence of peculiar unpleasant smell, and 3: no presence of peculiar unpleasant smell.

Average values obtained by averaging the evaluation values of the respective panels were regarded as evaluated values.

TABLE 4

| Test | Evaluated value |
|---|---|
| Example 2 | 2.4 |
| Comparative Example 2 | 1.7 |

As is clear from Table 4, the dressing prepared by using the vinegar containing ammonia at a concentration of 100 mg/100 ml (Example 2) was confirmed to have a significantly reduced peculiar unpleasant smell of the vinegar as compared to the dressing prepared by using the vinegar containing ammonia at a concentration of 20 mg/100 ml (Comparative Example 2).

### Example 3, Comparative Example 3

### Production of Sesame Sauce

The vinegar of Example 1 (30 parts by weight), cooking oil (25 parts by weight), sugar (10 parts by weight), sesame paste (6 parts by weight), soy sauce (5 parts by weight), sesame oil (3 parts by weight), and egg yolk (2 parts by weight) were mixed using a high-speed mixer to produce an emulsion, to thereby prepare a sesame sauce of Example 3.

On the other hand, the respective raw materials were mixed to produce an emulsion at the same ratio as above except that the vinegar of Comparative Example 1 was used, to thereby prepare a sesame sauce of Comparative Example 3.

The sesame sauce of Example 3 and the sesame sauce of Comparative Example 3 were subjected to organoleptic tests by 15 panels to evaluate the flavor of the sesame sauces. The results are shown in Table 5.

Note that evaluation was conducted according to the following 3 scales, that is, 1: presence of peculiar unpleasant smell, 2: almost no presence of peculiar unpleasant smell, and 3: no presence of peculiar unpleasant smell. Average values obtained by averaging the evaluation values of the respective panels were regarded as evaluated values.

TABLE 5

| Test | Evaluated value |
|---|---|
| Example 3 | 2.5 |
| Comparative Example 3 | 1.8 |

As is clear from Table 5, the sesame sauce prepared by using the vinegar containing ammonia at a concentration of 100 mg/100 ml (Example 3) was confirmed to have a significantly reduced peculiar unpleasant smell of the vinegar as compared to the sesame sauce prepared by using the vinegar containing ammonia at a concentration of 20 mg/100 ml (Comparative Example 3).

1-6. (canceled)

7. An improved method of producing a vinegar, comprising producing a vinegar from a bran-containing raw material, the improvement comprising incorporating ammonia and sugar into the vinegar, the ammonia concentration being from 40 to 250 mg/100 ml of vinegar and the sugar concentration being from 5 to 50 g/100 ml of vinegar by at adding least an ammonia-containing material to the vinegar.

8. The method of producing a vinegar according to claim 7, comprising adding a sugar-containing material to the vinegar together with an ammonia-containing material.

9. The method according to claim 7, wherein the ammonia concentration is 100 to 200 mg/100 ml of vinegar.

10. The method according to claim 8, wherein the ammonia concentration is 100 to 200 mg/100 ml of vinegar.

11. An improved vinegar which is produced from a bran-containing raw material, the improvement comprising said vinegar contains ammonia and sugar, the ammonia concentration being 40 to 250 mg/100 ml and the sugar concentration being 5 to 50 g/100 ml.

12. An improved vinegar which is produced from a bran-containing raw material, the improvement comprising said vinegar contains ammonia and sugar, the ammonia concentration being 100 to 200 mg/100 ml and the sugar concentration being 5 to 50 g/100 ml.

13. A food or beverage comprising the vinegar according to claim 11.

14. A food or beverage comprising the vinegar according to claim 12.
